(19) United States
(12) Patent Application Publication
(10) Pub. No.: US 2026/0148877 A1
(43) Pub. Date: May 28, 2026

(54) POLYMER COMPOSITION SUITABLE FOR ELECTROSTATIC DISCHARGE APPLICATIONS

(71) Applicant: SYENSQO SPECIALTY POLYMERS USA, LLC, Alpharetta, GA (US)

(72) Inventors: Sheng Ying Qian, Shanghai (CN); Xiaoling Lynn Xu, Cumming, GA (US)

(73) Assignee: SYENSQO SPECIALTY POLYMERS USA, LLC, Alpharetta, GA (US)

(21) Appl. No.: 19/122,146

(22) PCT Filed: Oct. 17, 2022
(86) PCT No.: PCT/CN2022/125560

§ 371 Date: Apr. 17, 2025

(51) Int. Cl. H01B 1/24; C08J 3/20; C08K 7/06; C08K 9/00; C08L 71/00; H05F 3/00

(52) U.S. Cl. CPC H01B 1/24; C08J 3/201; C08K 7/06; C08K 9/00; C08L 71/00; C08J 2371/10; C08J 2481/06; C08K 2201/001; H05F 3/00

(57) ABSTRACT

A polyarylether composition (C) comprising: at least one poly (aryl ether ketone) polymer (“PAEK polymer”), at least one poly (biphenyl ether sulfone) polymer (“PPSU polymer”) and/or polyethersulfone (“PES polymer”), at least one electrically conductive fibrous carbon-based filler (“component B1”), and at least one electrically conductive particulate carbon-based filler (“component B2”). An article, particularly for electrostatic dissipative applications, such as a substrate carrier, comprising the polyarylether composition (C). The polymer composition is suitable for electrostatic discharge application.

### TECHNICAL FIELD

The present invention relates to a reinforced polyarylether composition, notably suitable for electrostatic discharge applications and to an article comprising it or made therefrom.

### BACKGROUND

It is known that conductive thermoplastic polymer compositions can be applied for protection from electrostatic discharge (ESD). These specialty polymer compositions are generally tailored to span the surface resistivity spectrum, and can often be formulated for injection molding or extrusion processes.

Multiple technologies are available to impart conductive properties into thermoplastic resins that are otherwise insulative in nature, providing the exact degree of conductivity required for ESD protection. Among others, a conductive filler can be added to the thermoplastic polymer.

It is known that micro-sized electrically conductive fillers, such as chopped carbon fiber or milled carbon fiber, is one of the most important filler materials.

For example, U.S. Pat. No. 5,820,788 discloses antistatic polymers containing a mixture of a thermoplastic resin and about 8-20% by weight of conductive partially carbonized chopped linear carbonaceous fibers having a carbon content of about 70-85%, which can further provide static control materials and structures with surfaces having controlled surface resistivities in the range of 10⁴ to 10¹⁰ Ω/sq.

Mold shrinkage is the shrinkage of the polymer as it cools after the molding process. It is typically used to properly machine injection molds so that final part dimensions are as desired. Thus, there are still needs for optimizing conductive thermoplastic polymer composition in order to improve the mold shrinkage of filled ESD polymer material by using standard electrically conductive carbon fillers, which have higher carbon content.

### SUMMARY

Hence a first object of the present invention relates to a polyarylether composition (C) comprising:
at least one poly(aryl ether ketone) polymer (hereinafter “PAEK polymer”),
at least one poly(biphenyl ether sulfone) polymer (hereinafter “PPSU polymer”) and/or polyethersulfone (hereinafter “PES polymer”),
at least one electrically conductive fibrous carbon-based filler (hereinafter “component B1”), and
at least one electrically conductive particulate carbon-based filler (hereinafter “component B2”).

Another object of the present invention relates to an article comprising, or made from, said polyarylether composition (C), said article having a volume resistivity, measured according to ASTM D257, of from 1·10⁺⁵ Ω·cm up to 5·10⁺¹² Ω·cm.

The Applicant has found that the polyarylether composition (C) of the present invention, as detailed herein, thanks to the blending of the PAEK, the PPSU polymer and/or the PES polymer with the component B1 and the component B2, is effective in improving the mold shrinkage of filled ESD polymer material, without sacrificing the mechanical performance.

### DETAILED DESCRIPTION OF PREFERRED EMBODIMENTS

The polyarylether composition (C) according to the present invention may comprise:
collectively from 40 wt. % to 90 wt. % of the PAEK polymer and the PPSU polymer and/or PES polymer, and
collectively from 10 wt. % to 60 wt. % of the components B1 and B2, said wt. % being based on the total weight of the polyarylether composition (C).

The polyarylether composition (C) according to the present invention may comprise:
collectively from 50 wt. % to 80 wt. % of the PAEK polymer and the PPSU polymer and/or PES polymer, and
collectively from 20 wt. % to 50 wt. % of the components B1 and B2,
   said wt. % being based on the total weight of the polyarylether composition (C).

The polyarylether composition (C) according to the present invention may comprise:
collectively from 60 wt. % to 80 wt. % of the PAEK polymer and the PPSU polymer and/or PES polymer, and
collectively from 20 wt. % to 40 wt. % of the components B1 and B2,
   said wt. % being based on the total weight of the polyarylether composition (C).

The polyarylether composition (C) according to the present invention may comprise:
at least 30 wt. % and at most 50 wt. % of the PAEK polymer,
at least 20 wt. % and at most 40 wt. % of the PPSU polymer and/or PES polymer,
at least 5 wt. % and at most 25 wt. % of the component B1, and
at least 5 wt. % and at most 25 wt. % of the component B2,
   said wt. % being based on the total weight of the polyarylether composition (C).

The polyarylether composition (C) according to the present invention may comprise:
at least 35 wt. % and at most 45 wt. % of the PAEK polymer,
at least 25 wt. % and at most 35 wt. % of the PPSU polymer and/or PES polymer,
at least 10 wt. % and at most 20 wt. % of the component B1, and
at least 10 wt. % and at most 20 wt. % of the component B2,
   said wt % being based on the total weight of the polyarylether composition (C).

The polyarylether composition (C) according to the present invention, may further comprise optional additives, generally not exceeding 10 wt. % based on the total weight of the composition (C). The combined weights of the at least one PAEK polymer, the PPSU polymer and/or PES polymer, the component B1, the component B2 and optional additive(s) are equal to or less than 100 wt. % of the composition (C).

Some polyarylether compositions (C) according to the present invention may exclude a PES polymer. In such instances, the polyarylether composition (C) includes the PAEK polymer, the PPSU polymer, the components B1 and B2, but does not include a PES polymer. Thus any disclosure referring to “the PPSU polymer and/or PES polymer”, such as its weight content and ranges in the composition (C) as provided herein, is equally applicable to polyarylether compositions (C) of the present invention in which the PPSU polymer is present and in which a PES polymer is absent.

### The Poly(Aryl Ether Ketone) (PAEK)

As previously mentioned, the polyarylether composition (C) comprises at least one PAEK polymer.

For the purpose of the present invention, the term “poly(aryl ether ketone)” or “PAEK” is intended to denote any polymer of which more than 50 wt. %, at least 60 wt. %, at least 70 wt. %, at least 80 wt. %, at least 90 wt. %, at least 95 wt. %, at least 99 wt. % of the recurring units are recurring units (R1) of one or more of the following formulae (I) to ((V):

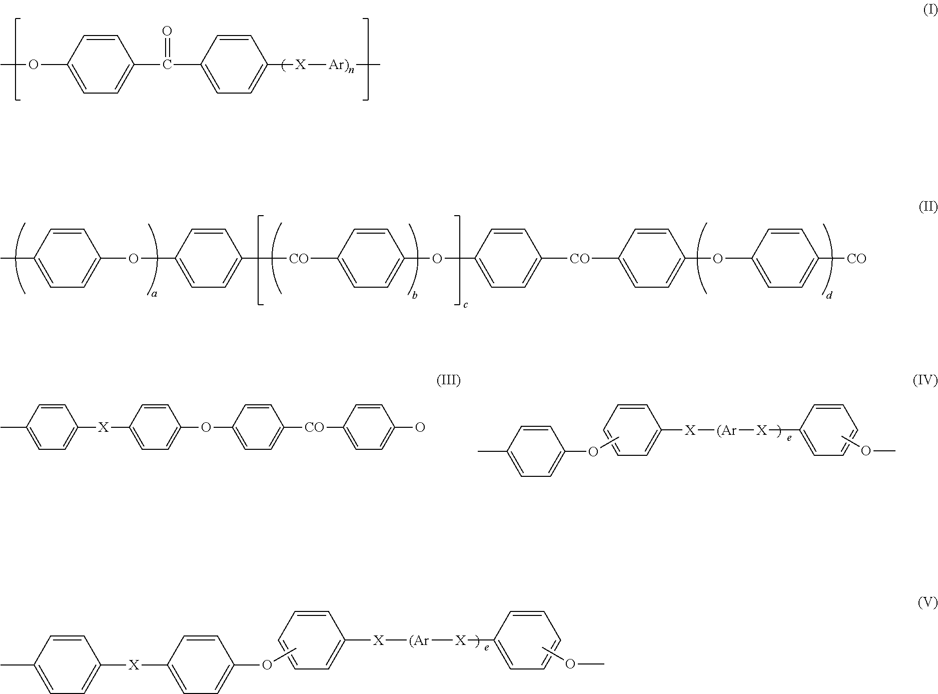

wherein:
Ar is independently a divalent aromatic radical selected from phenylene, biphenylene or naphthylene,
X is independently O, C(═O) or a direct bond,
n is an integer from 0 to 3,
b, c, d and e are 0 or 1,
a is an integer from 1 to 4, and
preferably, d is 0 when b is 1.

Recurring units (R1) may notably be chosen from:

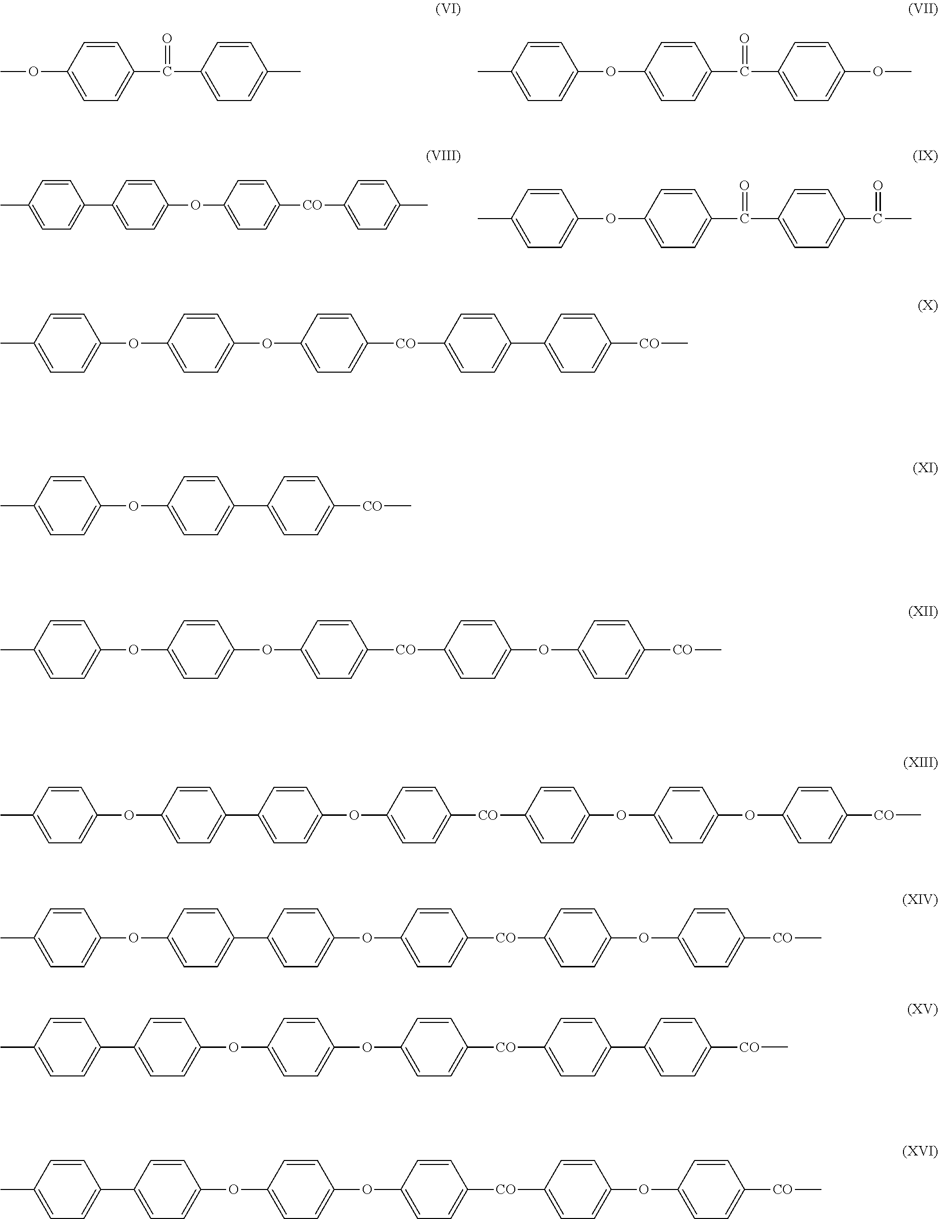

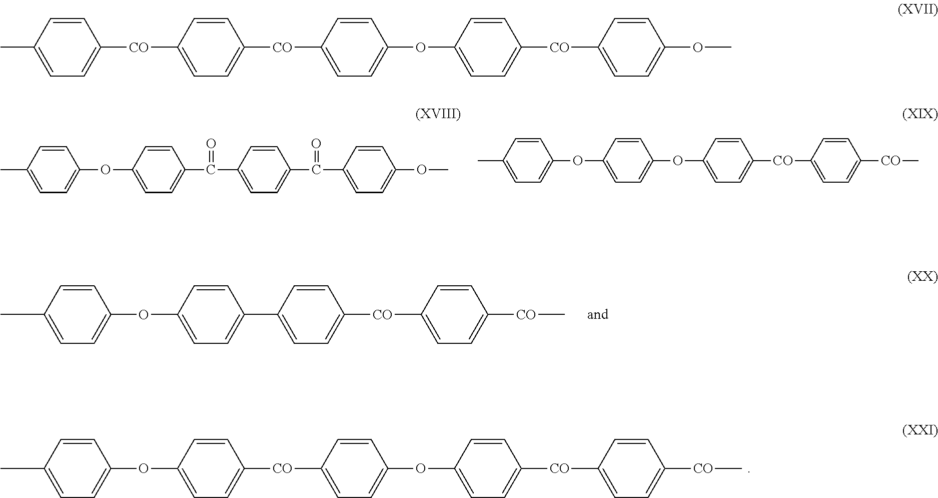

Preferably, recurring (R1) are chosen from:

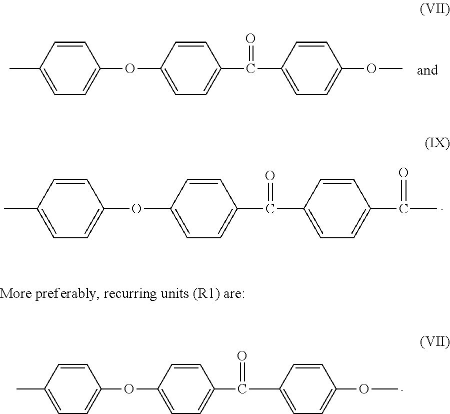

For the purpose of the present invention, a polyetheretherketone (PEEK polymer) is intended to denote any polymer of which more than 50 wt. % of the recurring units are recurring units (R1) of formula (VII). Preferably, at least 60 wt. %, at least 70 wt. %, at least 80 wt. %, at least 90 wt. %, at least 95 wt. %, at least 99 wt. % of the recurring units of the PEEK polymer are recurring units (R1) of formula (VII). Still more preferably, essentially all the recurring units of the PEEK polymer are recurring units (R1) of formula (VII). The most preferably, all the recurring units of the PEEK polymer) are recurring units (R1) of formula (VII).

Preferably, the PAEK used for the present invention is not sulfonated.

Excellent results are obtained when the PAEK polymer is a polyetheretherketone homopolymer, i.e. a polymer of which essentially all, if not all, the recurring units are of formula (VII). Non limitative examples of suitable commercially available PEEK homopolymers are VICTREX® PEEKs from Victrex Manufacturing Ltd., KETASPIRE® PEEKs from Solvay Specialty Polymers and Zypeek® from Jilin Joinature Polymer Co., Ltd.

The PAEK polymer can have an intrinsic viscosity (IV) of at least 0.50 dl/g, preferably at least 0.60 dl/g, more preferably at least 0.70 dl/g, as measured in 95-98% sulfuric acid (d=1.84 g/ml) at a PAEK concentration of 0.1 g/100 ml.

The PAEK polymer, for example PEEK polymer, may have a melt viscosity as high as 0.25 kPa-s, but preferably lower than 0.20 kPa-s and most preferably less than 0.18 kPa-s at 400° C. and a shear rate of 1000 s⁻¹, as measured using a capillary rheometer in accordance with ASTM D3835. The PAEK polymer, for example PEEK polymer, may have a melt viscosity as low as 0.05 kPa-s.

The PAEK polymer, for example PEEK polymer, may have a melt viscosity at 400° C. and a shear rate of 1000 s⁻¹, as measured using a capillary rheometer in accordance with ASTM D3835, ranging from 0.05 kPa-s to 0.25 kPa-s, preferably from 0.06 kPa-s to 0.20 kPa-s, preferably from 0.07 kPa-s to 0.18 kPa-s, preferably from 0.08 kPa-s to 0.15 kPa-s.

As a capillary rheometer, a Kayeness Galaxy V Rheometer (Model 8052 DM) may be used.

The PAEK polymer, for example PEEK polymer, can be prepared by any method.

One well known in the art method contains reacting a substantially equimolar mixture of at least one bisphenol and at least one dihalobenzoid compound or at least one halophenol compound as described in Canadian Pat. No. 847,963. Non limitative example of bisphenols useful in such a process are hydroquinone, 4,4′-dihydroxybiphenyl and 4,4′-dihydroxybenzophenone; non limitative examples of dihalobenzoid compounds useful in such a process are 4,4′-difluorobenzophenone, 4,4′-dichlorobenzophenone and 4-chloro-4′-fluorobenzophenone; non limitative examples of halophenols compounds useful in such a process are 4-(4-chlorobenzoyl)phenol and (4-fluorobenzoyl)phenol. Accordingly, PEEK homopolymers may notably be produced by the nucleophilic process as described in, for example, U.S. Pat. No. 4,176,222, the whole content of which is herein incorporated by reference.

Another well-known in the art method to produce PEEK homopolymers comprises electrophilically polymerizing phenoxyphenoxybenzoic acid, using an alkane sulfonic acid as solvent and in the presence of a condensing agent, as the process described in U.S. Pat. No. 6,566,484, the whole content of which is herein incorporated by reference. Other poly(aryl ether ketone)s may be produced by the same method, starting from other monomers than phenoxyphenoxybenzoic acid, such as those described in U.S. Pat. Appl. 2003/0130476, the whole content of which is also herein incorporated by reference.

The polyarylether composition (C) can comprise one and only one PAEK polymer. Alternatively, it can comprise two, three, or even more than three PAEK polymers. Certain preferred mixtures of PAEK polymers are mixtures consisting of (i) at least one poly(aryl ether ketone) (PAEK)-a of which more than 50 wt. % of the recurring units, preferably essentially all the recurring units, and still more preferably all the recurring units are of formula

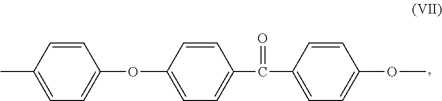

with (ii) at least one poly(aryl ether ketone) (PAEK)-b of which more than 50 wt. % of the recurring units, preferably essentially all the recurring units, and still more preferably all the recurring units are of formula

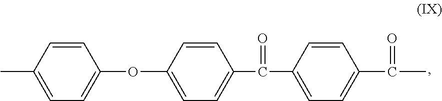

and, optionally in addition, with (iii) at least one other poly(aryl ether ketone) (PAEK)-c different from poly(aryl ether ketone)s (PAEK)-a and (PAEK)-b; in particular, mixes consisting of (i) at least one poly(aryl ether ketone) (PAEK)-a of which essentially all, if not all, the recurring units are of formula (VII) with (ii) at least one poly(aryl ether ketone) (PAEK)-b of which essentially all, if not all, the recurring units are of formula (IX); still more particularly, binary mixes consisting of (i) one poly(aryl ether ketone) (PAEK)-a of which all the recurring units are of formula (VII) with (ii) one poly(aryl ether ketone) (PAEK)-b of which all the recurring units are of formula (IX).

The amount of the PAEK polymer, based on the total weight of the polyarylether composition (C), is of at least 40 wt. %, preferably at least 41 wt. % or at least 42 wt. % or at least 43 wt. % or at least 44 wt. %, or at least 45 wt. %, or at least 47 wt. % or at least 49 wt. % or at least 55 wt. % or at least 55 wt. % and/or less than 89 wt. %, preferably at most 88 wt. %, or at most 87 wt. %, at most 86 wt. %, or at most 85 wt. %, or at most 80 wt. %, or at most 79 wt. %, or at most 78 wt. %, or at most 75 wt. %.

### The Poly(Biphenyl Ether Sulfone) Polymer (PPSU Polymer)

For the purpose of the invention, a poly(biphenyl ether sulfone) is intended to denote a polycondensation polymer of which at least 50 mol. %, at least 60 mol. %, at least 70 mol. %, at least 80 mol. %, at least 90 mol. %, at least 95 mol. %, or at least 99 mol. % of the recurring units are recurring units (R2) chosen from:

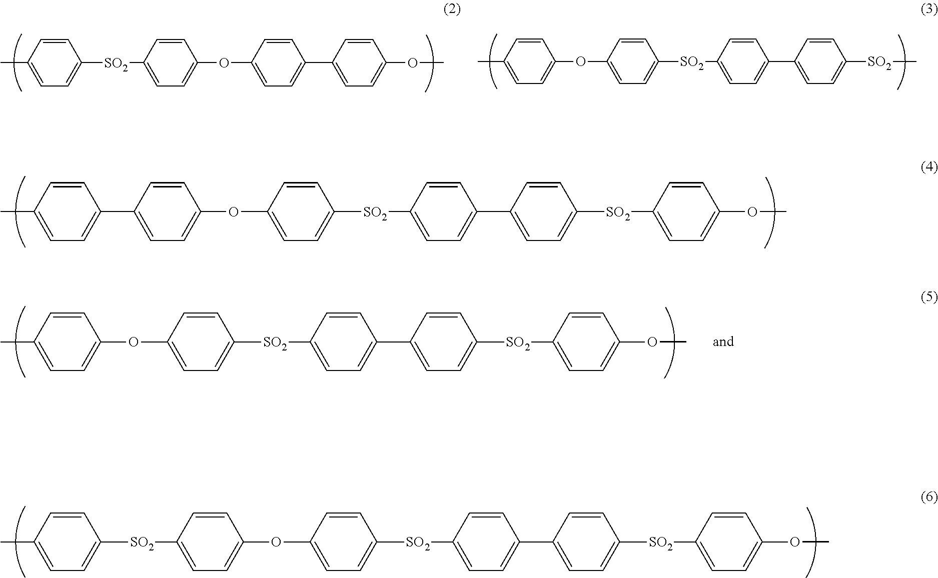

The mol. % is based on the total number of moles of recurring units in the poly(biphenyl ether sulfone) polymer.

Using recurring units of formula (2) in recurring units (R2) provides in general the best overall cost-properties balance, and the highest level of toughness. For the purpose of the present invention, a polyphenylsulfone is intended to denote any polycondensation polymer of which at least 50 mol % of the recurring units are recurring units (R2) of formula (2).

The poly(biphenyl ether sulfone) (PPSU polymer) may be notably a homopolymer, a random, alternating or block copolymer.

When the poly(biphenyl ether sulfone) (PPSU polymer) is a copolymer, its recurring units may notably be composed of (i) recurring units (R2) of at least two different formulae chosen from formulae (2) to (6), or (ii) recurring units (R2) of one or more formulae (2) to (6) (especially, recurring units of formula (2)) and recurring units (R2*), different from recurring units (R2), such as:

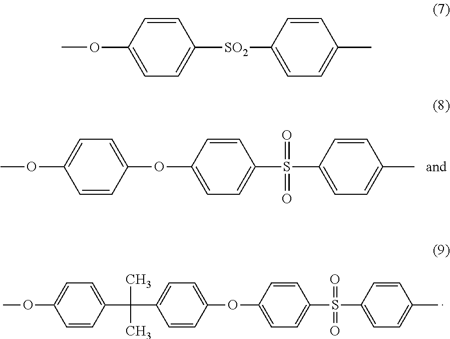

Preferably more than 70 mol. %, more preferably more than 85 mol. % of the recurring units of the poly(biphenyl ether sulfone) (PPSU polymer) are recurring units (R2) of formula (2), the mol. % being based on the total number of moles of recurring units in the poly(biphenyl ether sulfone) polymer. Still more preferably, essentially all the recurring units of the poly(biphenyl ether sulfone) (PPSU polymer) are recurring units (R2) of formula (2). Most preferably, all the recurring units of the poly(biphenyl ether sulfone) (PPSU polymer) are recurring units (R2) of formula (2).

Excellent results are in general obtained when the poly(biphenyl ether sulfone) (PPSU polymer) is a polyphenylsulfone homopolymer, i.e. a polymer of which essentially all, if not all, the recurring units are of formula (2). RADEL® polyphenylsulfone from Solvay Specialty Polymers USA, L.L.C. is an example of a polyphenylsulfone homopolymer.

The poly(biphenyl ether sulfone) (PPSU polymer) can be prepared by any method. Methods well known in the art are those described in U.S. Pat. Nos. 3,634,355; 4,008,203; 4,108,837 and 4,175,175, the whole content of which is herein incorporated by reference.

The polyarylether composition (C) may comprise one and only one poly(biphenyl ether sulfone) (PPSU polymer). Alternatively, it can comprise two, three, or even more than three poly(biphenyl ether sulfone)s (PPSU polymer).

### The Polyethersulfone (PES Polymer)

For the purpose of the invention, a polyethersulfone (PES polymer) denotes any polymer comprising at least 50 mol. %, at least 60 mol. %, at least 70 mol. %, at least 80 mol. %, at least 90 mol. %, at least 95 mol. %, or at least 99 mol. % of recurring units (R_{PES}) of formula (J):

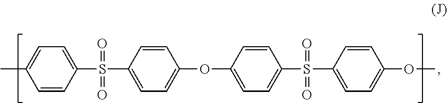

The mol. % is based on the total number of moles of recurring units in the PES polymer.

The PES polymer can be prepared by known methods, such as condensation of bisphenol S and dichlorodiphenol sulfone and is notably available as VERADEL® PESU from Solvay Specialty Polymers USA, L.L.C.

When a poly(biphenyl ether sulfone) (PPSU polymer) or a polyethersulfone (PES polymer) is present in the polyarylether composition (C), the weight of the PAEK polymer, based on the combined weights of the PAEK polymer and the PPSU polymer/the PES polymer in the polyarylether composition (C), is of at least 50 wt. %, preferably at least 60 wt. %, more preferably at least 70 wt. % and/or of at most 90 wt. %, preferably at most 80 wt. %.

Some polyarylether compositions (C) according to the present invention may not include a PES polymer.

### Carbon-Based Fillers

For the purpose of the present invention, the term “carbon-based filler” is intended to include graphitized, partially graphitized and ungraphitized carbon reinforcing fillers or any mixture thereof.

The term “graphitized” intends to denote carbon fillers obtained by high temperature pyrolysis (over 2000° C.) of carbon fillers, wherein the carbon atoms place in a way similar to the graphite structure.

Carbon-based fillers useful for the present invention can advantageously be obtained by heat treatment and pyrolysis of different polymer precursors such as, for example, rayon, polyacrylonitrile (PAN), aromatic polyamide or phenolic resin; carbon fillers useful for the present invention may also be obtained from pitchy materials.

Carbon-based fillers useful for the present invention are preferably chosen from the group composed of PAN-based carbon fillers, pitch-based carbon fillers, graphitized pitch-based carbon fillers, and mixtures thereof.

The carbon-based fillers useful for the present invention may be metalized. However, the carbon-based fillers useful for the present invention are preferably not metalized.

A fibrous filler is considered herein to be a tri-dimensional material having length, width and thickness, wherein the average length is significantly larger than both the width and thickness. Generally, such a material has an aspect ratio, defined as the ratio between the average length and the largest of the average width and average thickness of at least 5, at least 10, at least 20 or at least 50.

### The Electrically Conductive Fibrous Carbon-Based Filler (Component B1)

The component B1 in the polyarylether composition (C) is a fibrous filler having a purity of above 85% of elemental carbon, the remaining consisting possibly of residual impurities. Preferably, the component B1 contains at least 90% of elemental carbon, and more preferably at least 95% of elemental carbon. Good results are obtained when the purity of elemental carbon is above 85% and below 99%. In some embodiments, the component B1 consists essentially of elemental carbon.

In some embodiments, the component B1 is a fibrous filler having a purity of below 70% of elemental carbon, the remaining consisting possibly of residual impurities. Preferably, the component B1 contains at most 65% of elemental carbon, and more preferably at most 60% of elemental carbon.

The component B1 is a fibrous filler having an average length from 1 to 20 mm, preferably from 2 to 15 mm, more preferably from 3 to 10 mm, yet more preferably from 3 to 6 mm.

The component B1 is a fibrous filler generally having an equivalent diameter from 1 to 20 μm, preferably from 2 to 15 μm, more preferably from 3 to 10 μm, and most from 6 to 8 μm.

The component B1, based on the total weight of the polyarylether composition (C), is of at least 1 wt. %, preferably at least 5 wt. %, more preferably at least 10 wt. % and/or of at most 50 wt. %, preferably at most 40 wt. %, more preferably at most 30 wt. %.

Preferably, the component B1 has an electrical resistivity from 1.0 to 30 μΩ·m, preferably 2.0 to 20 μΩ·m and more preferably from 10 to 20 μΩ·m.

Advantageously, chopped carbon fibers are present in the polyarylether composition (C) as component B1. Chopped carbon fibers are commercially available notably from Teijin (such as PSC171100 Chopped carbon fibers, 3 mm) and from Procotex (such as APPLY CARBON chopped Carbon Fibers CF.OS.U1-6MM).

### The Electrically Conductive Particulate Carbon-Based Filler (Component B2)

Advantageously, milled carbon fibers are present in the polyarylether composition (C) as component B2.

Excellent results are obtained when the milled carbon fiber is a pitch-based carbon fiber.

Preferably, the milled carbon fiber is a pitch-based carbon fiber having an average length from 0.01 to 2 mm, preferably from 0.1 to 1 mm, more preferably from 0.2 to 0.8 mm.

Preferably, the milled carbon fiber is a pitch-based carbon fiber having an average diameter from 5 to 50 μm, preferably from 10 to 30 μm, more preferably from 10 to 15 μm.

Said pitch-based carbon fibers are commercially available notably from Osaka Gas Chemicals (OGC). In some embodiments, the milled carbon fiber is a PAN-based carbon fiber. PAN-based carbon fibers have advantageously a diameter of between 3 to 20 μm, preferably from 4 to 15 μm, more preferably from 5 to 10 μm, most preferably from 6 to 8 μm. Good results were obtained with PAN-based carbon fibers (PAN-CF) having a diameter of 7 μm.

Other suitable milled carbon fibers are commercially available as CF.LS-MLD80 to CF.LS-MLD250 from Procotex, with an average monofilament diameter of 7 microns, a medium length of 80-250 microns and a volume resistivity of 15·10⁻⁴ Ω·cm up to 20·10⁻⁴ Ω·cm.

The electrically conductive particulate carbon-based filler (component B2), based on the total weight of the polyarylether composition (C), is of at least 1 wt. %, preferably at least 10 wt. %, more preferably at least 15 wt. % and/or of at most 40 wt. %, preferably at most 30 wt. %, more preferably at most 20 wt. %.

Preferably, the component B2 has a volume resistivity about from 5.0 to 100 μΩ·m, preferably from 10.0 to 50 μΩ·m and more preferably from 15 to 45 μΩ·m.

Preferably, the combined weights of the components B1 and B2, based on the total weight of the polyarylether composition (C), is more than 10 wt. %, or at least 20 wt. %, or at least 25 wt. % and/or at most 50 wt. %, preferably at most 40 wt. %, more preferably at most 35 wt. %.

Advantageously, the weight of milled carbon fibers, based on the combined weights of milled and chopped carbon fibers in the composition, is more than 50 wt. %.

When the component B1 and component B2 are present in the polyarylether composition (C), the PAEK is preferably not cross-linked to the component B1 and/or the component B2.

### Optional Additives

In some embodiments, the polyarylether composition (C) according to the invention includes an additive selected from the group consisting of ultra-violet (“UV”) stabilizers, heat stabilizers, pigments, dyes, flame retardants, impact modifiers, lubricants, nucleating agents, antioxidants, processing aids, and any combination of one or more thereof.

In some embodiments in which the polyarylether composition (C) includes optional additives, the total concentration of additives is no more than 15 wt. %, no more than 10 wt. %, no more than 5 wt. %, no more than 1 wt. %, no more 0.5 wt. %, no more than 0.4 wt. %, no more than 0.3 wt. %, no more than 0.2 wt. %, or no more than 0.1 wt. %.

One or more pigments can be particularly desirable additives in the composition (C) to make a white, black or colored article. The pigment may be a black pigment such as carbon black, a white pigment such as zinc oxide, zinc sulfide, lithopone, antimony white and titanium dioxide (of rutile or anatase type, preferably rutile type), and/or a colored pigment. A pigment is generally present in an amount of from 0 to 6 wt. %, preferably from 0.05 to 5 wt. % and in particular from 0.1 to 3 wt. %, based on the total weight of the polyarylether composition (C).

Antioxidants can be particularly desirable additives in the polyarylether composition (C). Antioxidants can improve the heat and light stability of the polyarylether composition (C). For example, antioxidants that are heat stabilizers can improve the thermal stability of the composition during manufacturing (or in high heat application settings), for example, by making the polymer processable at high temperatures while helping to prevent polymer degradation.

### Method for Making the Polyarylether Composition (C)

The polyarylether composition (C) according to the invention can be made using methods well known in the art.

For example, the polyarylether composition (C) is made by melt-blending the at least one PAEK polymer, the PPSU polymer and/or the PES polymer, the electrically conductive fibrous carbon-based filler (component B1), the electrically conductive particulate carbon-based filler (component B2), and any optional components or additives. Any suitable melt-blending method may be used for combining the components of the polyarylether composition (C). For example, all of the components may be fed into a melt mixer, such as single screw extruder or twin screw extruder, agitator, single screw or twin screw kneader, or Banbury mixer. The components can be added to the melt mixer all at once or gradually in batches. When said components are gradually added in batches, a part of the components is first added and then is melt-mixed with the remaining part of the components, which are subsequently added, until an adequately mixed composition is obtained.

### Article

As previously mentioned, another aspect of the present invention further pertains to an article, preferably a shaped article, comprising, or made from said polyarylether composition (C).

The polyarylether composition (C), as above detailed, can be processed by usual melt processing techniques, including notably extrusion molding, injection molding, and compression molding, so as to provide a shaped article.

Such an article has a volume resistivity, measured according to ASTM D257, of from 1·10⁺⁵ Ω·cm up to 5·10⁺¹² Ω·cm.

It has been found that the article has a surface resistivity of at least 10⁶ and at most 10⁹ Ω/sq.

Volume resistivity is the resistance to leakage current through the body of an insulating material. Surface resistivity is the resistance to leakage current along the surface of an insulating material.

It has been found that the article has a flow mold shrinkage of at most 0.60%, at most 0.50%, preferably from 0.10 to 0.60%, or more preferably from 0.10 to 0.25%, based on method ASTM D955 and/or has a transversal mold shrinkage of at most 0.8%, preferably from 0.1 to 0.6%, more preferably from 0.2 to 0.5%, based on method ASTM D955.

In a preferred embodiment, the ratio of the flow mold shrinkage to the transversal mold shrinkage from 1:1 to 1:2.5 and preferably from 1:1 to 1:2.

As used herein, the term “mold shrinkage” refers to the shrinkage of the polymer as it cools after the molding process. It is typically used to properly machine injection molds so that final part dimensions are as desired. A flow mold shrinkage refers to a mold shrinkage in the flow direction. A transversal mold shrinkage (or cross-flow mold shrinkage) refers to a mold shrinkage in the transverse (cross-flow) direction.

The shaped article according to the invention is preferably selected from the group consisting of (i) an extruded shape, preferably selected from the group consisting of a rod, a slab, a tubing, a pipe or a profile; and (ii) an injection molded article.

According to certain embodiments shaped articles are under the form of substantially bidimensional articles, e.g. parts wherein one dimension (thickness or height) is significantly less than the other two characterizing dimensions (width and length), such as films, sheaths and sheets.

According to other embodiments, shaped articles are provided as three-dimensional parts, e.g. substantially extending in the three dimensions of space in similar manner, including under the form of parts with complex geometries, e.g. with concave or convex sections, possibly including undercuts, inserts, and the like.

The polyarylether composition (C) may be used to make electrostatic dissipative articles for example but not limited to substrate carriers. Substrate carriers may include but not limited to wafer carriers, reticle pods, shippers, chip trays, test sockets, head trays (read and/or write); fluid tubing, chemical containers, and the like.

Shaped articles may include but are not limited to portions or all of reticle carriers as illustrated in U.S. Pat. Nos. 6,513,654 and 6,216,873; disk shippers as illustrated in U.S. Pat. Nos. 4,557,382 and 5,253,755; chip trays as illustrated in U.S. Pat. No. 6,857,524; wafer carriers as illustrated in U.S. Pat. No. 6,848,578; wherein each of these references is incorporated herein by reference in its entirety into the present application.

According to certain embodiments, shaped articles made from the polyarylether composition (C), as above detailed, are provided as part(s) of an electrostatic discharge (ESD) protective device, which may, e.g., be designed for being connected to a semiconductor wafer intended for chip manufacture.

### EXAMPLES

The invention will now be described with reference to the following examples, whose purpose is merely illustrative and not intended to limit the scope of the invention. As used in the Examples, “E” denotes an example embodiment of the present invention and “CE” denotes a counter-example.

### Materials

PEEK: Ketaspire® KT-880P from Solvay Specialty Polymers
PPSU: Radel® R-5900 from Solvay Specialty Polymers
Component B1: PSC171100 3-mm chopped Carbon Fibers from Teijin
Component B2: Pitch based CF powders DONACARBO S-2415 from OGC
Optional additives: Zinc oxide “Zinkoxyd aktiv” from Lanxess

### Test Methods

### Tensile Properties—ISO 527

Tensile modulus, tensile strength, and elongation at break were measured on 5 injection molded ISO Type 1a tensile specimens (total length=170 mm, gauge length=50 mm, testing section width=10 mm, and thickness=4 mm)

### Impact Strength—ISO 180

Notched and un-notched Izod impact strength properties were measured in kJ/m² using 10 injection molded ISO type 1A bars (length of 80±2 mm, width of 10±0.2 mm, thickness of 4±0.2 mm).

### Mold Shrinkage—ISO 294 (ASTM D955)

Mold shrinkage (mold shrinkage in Flow Direction (%) and in Transverse Direction (%)) was measured on 5 injection molded plaques with dimensions 60 mm width by 60 mm length by 2 mm thick.

### Volume and Surface Resistivity—ASTM D257

Volume and surface resistivities were measured on 5 injection molded plaques with dimensions 4″×4″×⅛″ (length×width×thickness) or 60 mm×60 mm×2 mm (length×width×thickness)

### Example 1

The resins, fillers and additives were fed to a ZSK-26 mm co-rotating twin screw extruder using gravimetric feeders that were adjusted for each run to achieve the target blend ratio in Table 1.

The compounding conditions for all the blends and controls are shown in Table 2. The set points on the extruder were the same for all the runs.

The composition prepared was then processed by injection molding according to ASTM D3641 to provide a shaped article.

TABLE 1

| | Composition | Composition | Composition |
|---|---|---|---|
| Raw Material | for E1 | for CE2 | for CE3 |
| PEEK | 42 | 70 | 70 |
| PPSU | 27.9 | — | — |
| B1 | 14 | 14 | — |
| B2 | 16 | 16 | 30 |
| ZnO | 0.1 | — | — |

TABLE 2

| Barrel Configuration | | |
|---|---|---|
| Target Melt Temp (° C.) | | Value |
| Feed | Barrel 1, temp (° C.) | 80 |
| Top Plug & Side Plug | Barrel 2, temp (° C.) | 350 |
| Solid | Barrel 3, temp (° C.) | 370 |
| Solid | Barrel 4, temp (° C.) | 380 |
| Top Vent & Side Feed | Barrel 5, temp (° C.) | 370 |
| Solid | Barrel 6, temp (° C.) | 370 |
| Top Plug & Side Plug | Barrel 7, temp (° C.) | 370 |
| Solid | Barrel 8, temp (° C.) | 370 |
| Solid | Barrel 9, temp (° C.) | 370 |
| Side Vacuum | Barrel 10, temp (° C.) | 370 |
| Solid | Barrel 11, temp (° C.) | 370 |
| Solid | Barrel 12, temp (° C.) | 370 |

| | |
|---|---|
| Die Temp (° C.) | 270 |
| Screw Speed (RPM) | 220~250 |
| Screw Torque (%) | 65~80 |
| Vacuum Level (mmHg) | 0.9 |
| Pelletizer Speed (m/min) | 20~22 |
| Throughput(Kg/hr) | 14 |

### Comparative Example 2

The components to prepare sample CE2 are listed in Table 1.

The composition and the shaped article of Comparative Example 2 were prepared in the same way as Example 1.

### Comparative Example 3

The components to prepare sample CE3 are listed in Table 1.

The composition and the shaped article of Comparative Example 3 were prepared in the same way as Example 1.

As shown by the results in Table 3, the composition E1 according to the invention was effective in optimizing the mold shrinkage of the article, reducing the flow and transverse mold shrinkages to 0.24% and 0.47%, respectively, in comparison the higher flow and transverse mold shrinkages (0.28% and 0.81%, respectively) of the CE2 sample which did not comprise PPSU. Thanks to the composition E1, the difference between the flow mold shrinkage and the transversal mold shrinkage is smaller, in comparison with the CE2 sample.

The composition E1 was effective in optimizing the mold shrinkage of the article, reducing the transverse mold shrinkages to 0.47%, in comparison the higher transverse mold shrinkages (0.83%) of the CE3 sample which did not comprise PPSU and comprised only component B2. Thanks to the composition E1, the difference between the flow mold shrinkage and the transversal mold shrinkage is smaller, in comparison with the CE3 sample.

TABLE 3

| | Samples | | |
|---|---|---|---|
| | E1 | CE2 | CE3 |
| Comment | PEEK/PPSU | PEEK | PEEK |

Mechanical Data

| | | | | |
|---|---|---|---|---|
| Tensile Strength | MPa | 149 | 191 | 259 |
| Tensile Elongation | % | 1.7 | 1.8 | 1.8 |
| Tensile Modulus | Gpa | 13.8 | 17.2 | 27.5 |
| Izod Strength (Notched) | kJ/m² | 4.9 | 4.6 | 7.5 |
| Izod Strength (Unnotched) | kJ/m² | 30 | 33 | 80 |

Basic physical properties

| | | | | |
|---|---|---|---|---|
| Density | g/cm³ | 1.38 | 1.37 | 1.41 |
| Mould Shrinkage (Flow) | % | 0.24 | 0.28 | 0.18 |
| Mould Shrinkage (x-Flow) | % | 0.47 | 0.81 | 0.83 |

Electrical Properties

| | | | | |
|---|---|---|---|---|
| Volume Resistivity @25 V | Ω cm | 10⁷ | 10⁷ | 10⁷ |
| Surface Resistivity @ | Ω/sq | 10⁷ | 10⁷ | Not |
| 100 V | | | | detected |

*x-Flow represents the transversal shrinkage.

The disclosure of all patent applications, and publications cited herein are hereby incorporated by reference, to the extent that they provide exemplary, procedural or other details supplementary to those set forth herein. Should the disclosure of any patents, patent applications, and publications which are incorporated herein by reference conflict with the description of the present application to the extent that it may render a term unclear, the present description shall take precedence. Any incorporation by reference of documents is limited such that no subject matter is incorporated that is contrary to the explicit disclosure herein.

While preferred embodiments of this invention have been shown and described, modifications thereof can be made by one skilled in the art without departing from the teaching of this invention. The embodiments described herein are exemplary only and are not limiting. Many variations and modifications of compositions, articles, and methods are possible and are within the scope of the invention. Accordingly, the scope of protection is not limited by the description set out above, but is only limited by the claims which follow, that scope including all equivalents of the subject matter of the claims. Each and every claim is incorporated into the specification as an embodiment of the present invention. Thus, the claims are a further description and are an addition to the preferred embodiments of the present invention.

We claim:

1. A polyarylether composition (C) comprising:
at least one poly(aryl ether ketone) polymer (“PAEK polymer”),
at least one poly(biphenyl ether sulfone) polymer (“PPSU polymer”) and/or polyethersulfone (“PES polymer”),
at least one electrically conductive fibrous carbon-based filler (“component B1”), and
at least one electrically conductive particulate carbon-based filler (“component B2”),
wherein chopped carbon fibers are present in the polyarylether composition (C) as component B1 and milled carbon fibers are present in the polyarylether composition (C) as component B2.

2. The polyarylether composition (C) according to claim 1, wherein the PAEK polymer comprises, based on the total weight of recurring units in the PAEK polymer, more than 50 wt. % of recurring units (R_{PAEK}) represented by any formula selected from following formulae (I) to ((V): 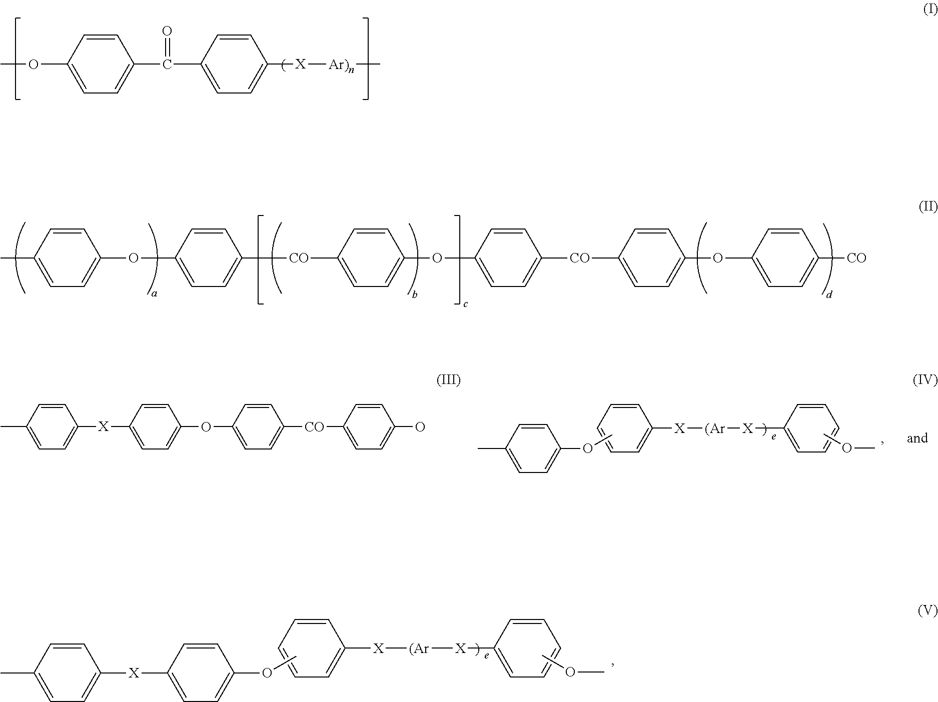
wherein:
Ar is independently a divalent aromatic radical selected from phenylene, biphenylene or naphthylene,
X is independently O, C(═O) or a direct bond,
n is an integer from 0 to 3,
b, c, d and e are 0 or 1, and
a is an integer from 1 to 4.

3. The polyarylether composition (C) according to claim 1, wherein the polyarylether composition (C) comprises, based on the total weight of the polyarylether composition (C), combined weights of the components B1 and B2 of more than 20 wt. %.

4. (canceled)

5. The polyarylether composition (C) according to claim 3, wherein the weight of milled carbon fibers, based on the combined weights of milled and chopped carbon fibers in the polyarylether composition (C), is more than 50 wt. %.

6. The polyarylether composition (C) according to claim 1, wherein the polyarylether composition (C) comprises at least 50 wt. %, based on the combined weights of the PAEK polymer and the PPSU polymer and/or PES polymer in the polyarylether composition (C).

7. The polyarylether composition (C) according to claim 1, wherein the PPSU polymer comprises, based on the total moles of recurring units in the PPSU polymer, at least 50 mol. % of recurring units (R2) represented by any formula selected from following formulae (2) to (6):

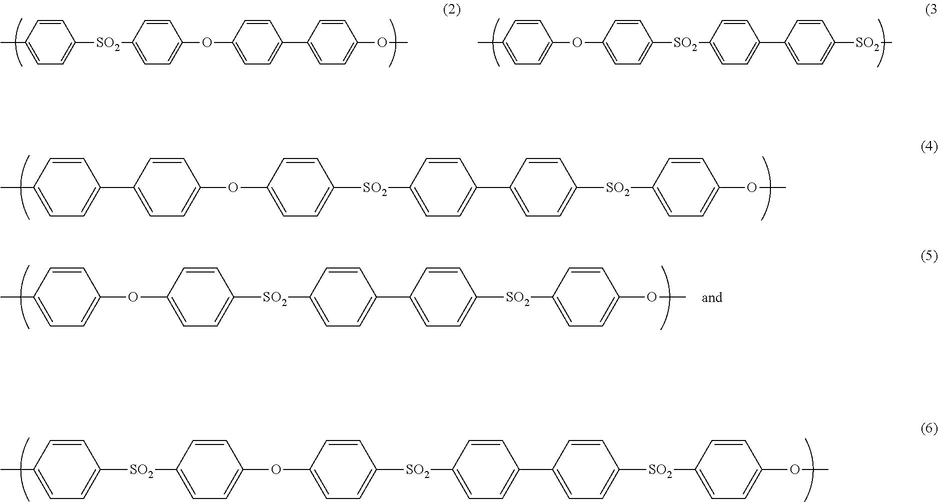

8. The polyarylether composition (C) according to claim 7, wherein more than 70 mol. % of the recurring units of the poly(biphenyl ether sulfone) (PPSU polymer) are recurring units (R2) of formula (2).

9. The polyarylether composition (C) according to claim 1, wherein the polyethersulfone (PES polymer) comprises, based on the total number of moles of recurring units in the PES polymer, at least 50 mol. % of recurring units (R_{PES}) of formula (J):

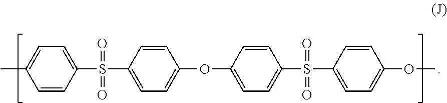

10. (canceled)

11. The polyarylether composition (C) according to claim 1, comprising:
collectively from 40 wt. % to 90 wt. % of the PAEK polymer and the PPSU polymer and/or PES polymer, and
collectively from 10 wt. % to 60 wt. % of the components B1 and B2,
said wt % being based on the total weight of the polyarylether composition (C).

12. The polyarylether composition (C) according to claim 1, comprising:
at least 30 wt. % and at most 50 wt. % of the PAEK polymer,
at least 20 wt. % and at most 40 wt. % of the PPSU polymer and/or PES polymer,
at least 5 wt. % and at most 25 wt. % of the component B1, and
at least 5 wt. % and at most 25 wt. % of the component B2,
said wt. % being based on the total weight of the polyarylether composition (C).

13. A method for making the polyarylether composition (C) according to claim 1, comprising melt-blending the PAEK polymer, the PPSU polymer and/or the PES polymer, the component B1, the component B2, and optional additives.

14. An article comprising, or made from, the polyarylether composition (C) of claim 1, said article having a volume resistivity, measured according to ASTM D257, of from 1·10⁺⁵ Ω·cm up to 5·10⁺¹² Ω·cm.

15. The article of claim 14, having a flow mold shrinkage of at most 0.60%, based on method ASTM D955 and/or having a transversal mold shrinkage of at most 0.8%, based on method ASTM D955.

16. The article of claim 14, having a surface resistivity of at least 10⁶ and at most 10⁹ Ω/sq.

17. The article of claim 14, being a substrate carrier selected from the group consisting of wafer carriers, reticle pods, shippers, chip trays, test sockets, head trays, fluid tubing, and chemical containers.
